(19) United States
(12) Patent Application Publication
(10) Pub. No.: US 2026/0248122 A1
(43) Pub. Date: Aug. 27, 2026

(54) Body Tissue Preservation Systems and Methods

(71) Applicant: Scubatx Limited, Royston (GB)

(72) Inventors: Stuart KAY, Royston (GB); William Earl SCOTT, III, Royston (GB)

(21) Appl. No.: 18/879,462

(22) PCT Filed: Jul. 4, 2023
(86) PCT No.: PCT/GB2023/051751

§ 371 Date: Dec. 27, 2024

(30) Foreign Application Priority Data
Jul. 4, 2022 (GB) 2209781.0

(51) Int. Cl. A01N 1/143

(52) U.S. Cl. CPC A01N 1/143

(57) ABSTRACT

The present application discloses a body tissue preservation system (100) for storage and preservation of body tissue (102), the system comprising a base unit (110), a container unit (120), a sensor and a controller. The base unit is arranged to house the container unit and to connect it to a supply of persufflation gas; the container unit is arranged to receive the body tissue, and comprises one or more delivery channels arranged to receive persufflation gas from the base unit and to deliver said persufflation gas to the body tissue; the sensor (131-134) is arranged to sense one or more properties of downstream persufflation gas which has passed through the body tissue; and the controller is configured to determine an indication of a status, such as an amount of oxygen uptake, of the body tissue based on the one or more sensed properties of the downstream persufflation gas. The sensor may comprise an oxygen sensor.

### TECHNICAL FIELD

The present disclosure relates to the technical field of preserving body tissue. In particular, body tissue preservation systems and methods are disclosed which provide a persufflation gas to body tissue being stored.

### BACKGROUND

In some cases, one or more organs may be harvested from a person after they have died (or voluntarily while still alive), and these organs can be used in another person. In which case, a surgeon may remove a relevant organ from the patient. The organ is then transferred so that it can be inserted into another patient. During this process, there will be a time period in which the organ is not connected to either patient; and this organ is to be maintained in a suitable state so that it may still be useful once it has been inserted into a patient. In this time period the organ may have to be transported, such as from one hospital to another. Storage apparatuses have been disclosed which are designed to facilitate this transfer of an organ.

Aspects of the present disclosure seek to provide improved systems and methods for the storage and/or preservation of body tissue.

### SUMMARY

Aspects of the disclosure are set out in the independent claims and optional features are set out in the dependent claims. Aspects of the disclosure may be provided in conjunction with each other, and features of one aspect may be applied to other aspects.

In an aspect, there is provided a body tissue preservation system for storage and preservation of body tissue. The system comprises a base unit, a container unit, a sensor and a controller. The base unit is arranged to house the container unit and to connect the container unit to a supply of persufflation gas. The container unit is arranged to receive body tissue to be stored and preserved, and comprises one or more delivery channels arranged to receive persufflation gas from the base unit and to deliver said persufflation gas to the body tissue. A sensor is arranged to sense one or more properties of downstream persufflation gas which has passed through the body tissue. The controller is configured to determine an indication of a status of the body tissue based on the one or more sensed properties of the downstream persufflation gas.

Embodiments may enable sensor data to be obtained for the body tissue being stored without requiring direct contact with the body tissue. This may reduce the likelihood of sensor contact induced damage to the body tissue. Additionally, the use of downstream sensors may facilitate easier installation and use of those sensors, as compared to sensors which require direct contact with the body tissue. Downstream sensors may also enable use of a comparison between upstream and downstream sensor data for determining a status of the body tissue (e.g. based on uptake of the body tissue evident in the difference of sensed properties between upstream and downstream persufflation gas sensor data).

Determining an indication of a status of the body tissue may comprise determining a difference between: (i) a sensed property of the downstream persufflation gas, and (ii) a corresponding property of upstream persufflation gas to be provided to the body tissue. For example, the system may be configured to provide a flow of persufflation gas through the body tissue. That flow of gas may start upstream of the body tissue, where it may then be delivered to the body tissue. The persufflation gas may then flow through the body tissue (e.g. be passed through the body tissue). Once this persufflation gas has passed through the body tissue it may then be downstream (persufflation) gas (e.g. gas which has passed through the body tissue). The determined difference may be based on a difference between gas in the same flow through the body tissue. For example, the upstream gas may be that which is about to pass through the body tissue, and the downstream gas may be that upstream gas after it has passed through the body tissue to become downstream gas. Determining an indication of the status of the body tissue may comprise determining an uptake metric for the body tissue based on the determined difference between downstream and upstream persufflation gas. The sensor may comprise an oxygen sensor. Determining the status of the body tissue may comprise determining an amount of oxygen uptake into the body tissue. The determined amount of oxygen uptake into the body tissue may be based on a difference in oxygen concentration for upstream persufflation gas to be provided to the body tissue and downstream persufflation gas which has passed through the body tissue.

The sensor may be configured to sense other properties than oxygen concentration. The sensor may be configured to sense one or more biological properties in the downstream persufflation gas. For example, the sensor may be configured to sense an indication of at least one of: (i) gas composition (e.g. what substances are present in the gas), (ii) protein and/or gene expression (e.g. for the substances present in the gas), (iii) an acidity level (such as using a pH sensor). Additionally or alternatively, the sensor may be configured to sense PO2 values for the gas (e.g. a partial pressure of oxygen in the gas).

The controller may be arranged to output a control signal in the event that at least one of: (i) the determined difference between the upstream persufflation gas and the downstream persufflation gas is outside a selected difference range, (ii) the determined difference has changed by more than a threshold amount, and/or (iii) the determined difference has changed at more than a threshold rate of change. Outputting a command signal may comprise at least one of: (i) controlling operation of the body tissue preservation system based on the determined difference, and (ii) outputting a signal that the determined difference is outside the selected difference range. Outputting the signal may comprise outputting an alert (e.g. an audible, visual or tactile signal for attracting attention of a human operator), and/or it may comprise storing an indication of the signal (e.g. an indication that the determined difference is outside the selected range) in a report (e.g. a reporting file) for the storage and preservation of the body tissue. Controlling operation of the body tissue preservation system based on the determined difference may comprise adjusting one or more properties of the delivery of persufflation gas to the body tissue, such as controlling an amount and/or a rate of persufflation gas to be delivered to the body tissue.

The controller may be configured to disregard initial sensor data for the downstream persufflation gas for an initial time period after the persufflation gas is first delivered to the body tissue. The initial time period may be selected to enable ambient fluid to pass through the body tissue and be discarded. The ambient fluid may comprise fluid from prior to commencing persufflation of the body tissue. For example, the ambient fluid may comprise fluid that was present in the body tissue, or any component of the body tissue preservation system, such as a humidification chamber, container unit and/or base unit. In other words, the initial time period may be selected so that after the initial sensor data has been discarded, the subsequent sensor data is indicative of the storage (and persufflation) of the body tissue e.g. rather than being indicative of any conditions prior to commencing storage and persufflation of the body tissue).

The container unit may comprise a container unit exhaust outlet for discarding gas which has passed through the body tissue from the container unit. The system may comprise a filter at the container unit exhaust outlet. The sensor may be arranged to sense one or more properties of the downstream gas passing through the container unit exhaust outlet. The base unit may be coupled to the container unit exhaust outlet to receive the gas being discarded from the container unit. The sensor may be arranged to sense one or more properties of the gas in the base unit which has been received from the container unit exhaust outlet. The base unit may comprise a base unit exhaust outlet for discarding the gas received from the container unit exhaust outlet. The sensor may be arranged to sense one or more properties of the gas being discarded through the base unit exhaust outlet. The container unit may comprise one or more exhaust channels arranged to receive persufflation gas which has passed through the body tissue from the delivery channels. The sensor may be arranged to sense one or more properties of the gas in the exhaust channels.

In an aspect, there is provided a kit of parts for a body tissue preservation system for storage and preservation of body tissue. The kit comprises a base unit, a container unit, a sensor and a controller. The container unit is removably insertable into the base unit to be housed therein. The base unit and container unit are couplable to connect the container unit to a supply of persufflation gas. The container unit is arranged to receive body tissue to be stored and preserved, and comprises one or more delivery channels arranged for receiving persufflation gas from the base unit and for delivering said persufflation gas to the body tissue. The sensor is arranged to sense one or more properties of downstream persufflation gas which has passed through the body tissue. The controller is operable to determine an indication of a status of the body tissue based on the one or more sensed properties of the downstream persufflation gas.

In an aspect, there is provided a container unit for a body tissue preservation system for storage and preservation of body tissue. The container unit is arranged to receive body tissue to be stored and preserved. The container unit is arranged to be coupled to a base unit to be connected to a supply of persufflation gas. The container unit comprises one or more delivery channels arranged to receive persufflation gas from said base unit and to deliver the persufflation gas to the body tissue. The container unit comprises a sensor arranged to sense one or more properties of downstream persufflation gas which has passed through the body tissue and to output one or more signals indicative of said one or more sensed properties of the downstream persufflation gas to enable a controller to determine an indication of a status of the body tissue based on the one or more sensed properties of the downstream persufflation gas.

In an aspect, there is provided a base unit for a body tissue preservation system for storage and preservation of body tissue. The base unit is arranged to receive a container unit arranged to receive body tissue to be stored and preserved. The base unit is arranged to be coupled to said container unit to connect said container unit to a supply of persufflation gas for delivering the persufflation gas to the body tissue via one or more delivery channels of the container unit. The base unit is arranged to be coupled to said container unit to receive, from the container unit, downstream persufflation gas which has passed through the body tissue. The base unit comprises a sensor arranged to sense one or more properties of the downstream persufflation gas which has passed through the body tissue and to output one or more signals indicative of said one or more sensed properties of the downstream persufflation gas to enable a controller to determine an indication of a status of the body tissue based on the one or more sensed properties of the downstream persufflation gas.

In an aspect, there is provided a body tissue storage and preservation method using a body tissue preservation system comprising a base unit, a container unit arranged to receive the body tissue to be stored and preserved, and a sensor. The method comprises: providing persufflation gas from the base unit to the container unit and delivering the persufflation gas to the body tissue through one or more delivery channels of the container unit; receiving downstream persufflation gas which has passed through the body tissue; sensing one or more properties of the downstream persufflation gas; and determining an indication of a status of the body tissue based on the one or more sensed properties of the downstream persufflation gas.

Aspects of the present disclosure provide a computer program product comprising computer program instructions configured to program a controller to control operation of a body tissue preservation system to perform any of the methods disclosed herein.

### FIGURES

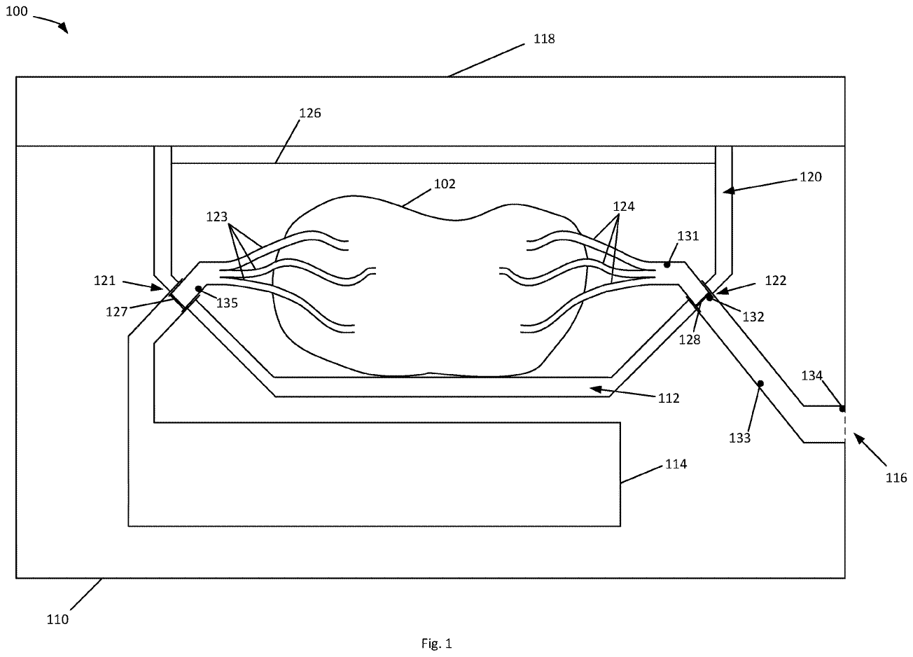

An example of the present disclosure will now be described, by way of example only, with reference to FIG. 1, which shows a body tissue preservation system.

### SPECIFIC DESCRIPTION

Embodiments of the present disclosure are directed to body tissue preservation systems and methods. A container unit is provided in a base unit. A body tissue to be stored and preserved, such as an organ, is placed in the container unit. Persufflation gas is supplied to the container unit from the base unit, and that persufflation gas is delivered to the body tissue in the container unit. One or more sensors are used to monitor properties of the persufflation gas after it has passed through the body tissue (e.g. in a region downstream of the body tissue). Sensor data for this downstream persufflation gas is used to infer one or more properties about a status of the body tissue being preserved. By comparing properties of the downstream persufflation gas to properties of upstream persufflation gas about to be provided to the body tissue, an indication of uptake for the body tissue may be deduced. Determined uptake properties for the body tissue may be used to infer a status for that body tissue. As one example, by determining a drop in oxygen percentage between upstream and downstream persufflation gas, an indication of how much oxygen is being consumed by the body tissue may be determined, which may be used to provide an indication of the health of that body tissue being stored and preserved.

An example of a body tissue preservation system will now be described with reference to FIG. 1.

FIG. 1 shows a body tissue preservation system 100. The system 100 includes a base unit 110 and a container unit 120. Body tissue 102 is shown in the container unit 120.

The base unit 110 includes a container unit receiving portion 112. The base unit 110 includes a persufflation gas store 114 and a base unit exhaust outlet 116. The base unit 110 has a base unit lid 118.

The container unit 120 includes an inlet gas coupling 121 and an exhaust gas coupling 122. The container unit 120 has one or more delivery channels 123 and one or more exhaust channels 124. The container unit 120 has a container unit lid 126. The container unit 120 may include one or more filters, such as inlet filer 127 and exhaust filter 128.

The system 100 also includes one or more sensors. Several examples for these sensor locations are shown in FIG. 1. This includes an exhaust channel sensor 131, a container unit exhaust outlet sensor 132, a base unit sensor 133, and a base unit exhaust outlet sensor 134. The system 100 may also include a gas inlet sensor, shown as a delivery channel sensor 135.

The container unit receiving portion 112 of the base unit 110 comprises a recess in the base unit 110 into which the container unit 120 is inserted. A body of the base unit 110 surrounds this container unit receiving portion 112 so as to house a container unit 120 within the base unit 110 in the container unit receiving portion 112. The lid 118 of the base unit 110 is located above the container unit receiving portion 112 for sealing the base unit 110 with the container unit 120 received in the container unit receiving portion 112.

The base unit 110 houses the persufflation gas store 114. The store may comprise a storage tank for storing pressurised gas. A gas supply line extends from the store towards the container unit receiving portion 112. The base unit 110 has two or more gas couplings for coupling to the container unit 120. A first gas coupling is a delivery gas coupling, and a second gas coupling is a discard gas coupling. The delivery gas coupling of the base unit 110 is arranged to couple to the inlet gas coupling 121 of the container unit 120. The discard gas coupling of the base unit 110 is arranged to couple to the exhaust gas coupling 122 of the container unit 120. The delivery gas coupling is located in the container unit receiving portion 112. The delivery gas coupling comprises means for coupling the gas supply line of the base unit 110 to the one or more gas delivery channels 123 of the container unit 120 (once the container unit 120 is inserted into the container unit receiving portion 112). The gas supply line extends from the store to the delivery gas coupling of the base unit 110.

The base unit exhaust outlet 116 is in the arranged at an outside surface of the base unit 110 (such as in a side, bottom or top surface of the base unit 110). For example the base unit exhaust outlet 116 may comprise a vent or other means for venting gas to the atmosphere. The discard gas coupling of the base unit 110 is coupled to the base unit exhaust outlet 116 via an exhausting delivery line. The discard coupling of the base unit 110 is located in the container unit receiving portion 112. The delivery gas coupling comprises means for coupling the one or more exhaust channels 124 of the container unit 120 to the exhausting delivery line of the base unit 110 (once the container unit 120 is inserted into the container unit receiving portion 112).

The container unit 120 defines a body tissue receiving portion into which the body tissue 102 to be stored and preserved is placed. The container unit 120 is shaped to define an internal volume which provides the body tissue receiving portion. The container unit lid 126 is arranged above the body tissue receiving portion for sealing the body tissue 102 in the body tissue receiving portion. The body tissue 102 may comprise a form of body tissue which is to be reused in another living being. For example, the body tissue 102 may comprise human or animal body tissue, such as a replacement organ (e.g. a heart, kidney etc.).

The inlet gas coupling 121 of the container unit 120 is arranged in the body tissue receiving portion for coupling from the internal volume of the body tissue receiving portion to an external side of the body tissue receiving portion (and to the delivery coupling of the base unit 110). The one or more gas delivery channels 123 of the container unit 120 are coupled to the inlet gas coupling 121. The gas delivery channels 123 may extend from the coupling, or they may branch out from further downstream of the inlet coupling 121. The inlet gas coupling 121 may comprise an aperture and/or valve in a body of the container unit 120 (to provide a gas flow path from outside the container unit 120 to inside the container unit receiving portion 112). The one or more delivery channels 123 extend to the body tissue 102. Each delivery channel 123 may be coupled with (e.g. inserted into) a corresponding lumen of the body tissue 102, such as an artery or vein.

The exhaust gas coupling 122 of the container unit 120 is arranged in the body tissue receiving portion for coupling from the internal volume of the body tissue receiving portion to an external side of the body tissue receiving portion (and to the discard coupling of the base unit 110). The one or more gas exhaust channels 124 of the container unit 120 are coupled to the exhaust gas coupling 122 of the container unit 120. The gas exhaust channels 124 may extend to the coupling, or they may branch together from further upstream of the inlet coupling 121. The exhaust gas coupling 122 may comprise an aperture and/or valve in a body of the container unit 120 (to provide a gas flow path from inside the container unit 120 to outside the container unit receiving portion 112). The one or more exhaust channels 124 extend from the body tissue 102. Each exhaust channel 124 may be coupled with (e.g. inserted into) a corresponding lumen of the body tissue 102, such as an artery or vein.

The system 100 is arranged so that the container unit 120 may be inserted into the container unit receiving portion 112 of the base unit 110. The container unit 120 will be held securely in place in the container unit receiving portion 112 of the base unit 110. The base unit 110 may be a re-usable device. The container unit 120 may be a disposable (single use) component.

With the container unit 120 inserted into the container unit receiving portion 112 of the base unit 110, the delivery coupling of the base unit 110 will be coupled to the inlet coupling 121 of the container unit 120. The exhaust coupling 122 of the container unit 120 will be coupled to the discard coupling of the base unit 110. The system 100 provides a gas flow path for persufflation gas with the container unit 120 inserted into the base unit 110. The persufflation gas may flow downstream from an upstream location. For this, persufflation gas starts in the persufflation gas store 114. Persufflation gas may then flow from the gas store 114 through the delivery line towards the container unit 120. The delivery coupling of the base unit 110 is coupled to the inlet coupling 121 of the container unit 120 so that gas flows from the delivery line of the base unit 110 and into the container unit 120 (through the coupling region). The gas flows into the one or more delivery channels 123, and into the body tissue 102 (e.g. into veins or arteries of the tissue). This gas may flow through the internal lumens of the body tissue 102 and out into corresponding exhaust channels 124 of the container unit 120. The discard coupling of the base unit 110 is coupled to the exhaust coupling 122 of the container unit 120 so that gas flows from the one or more exhaust channels 124 of the container unit 120 and into the base unit 110 (through the coupling region). The gas may flow along the exhausting line of the base unit 110 to the base unit exhaust outlet 116. This gas may then be exhausted to the environment through the base unit exhaust outlet 116.

In other words, the system 100 defines a flow path where persufflation gas flows from upstream to downstream. Upstream gas may be considered to be gas which is closer to the gas store 114 (along the gas flow path), and downstream gas may be considered to be gas which is closer to the base unit exhaust outlet 116 (along the gas flow path). In particular, upstream gas may be provided to the body tissue 102, and downstream gas may be received from the body tissue 102 for discarding as exhaust gas (e.g. gas which has not yet been delivered to the body tissue 102 may be considered upstream gas, and gas which has passed through the body tissue 102 may be considered downstream gas).

For the base unit 110, gas may flow from the gas store 114 to the delivery coupling. Gas may also be received back into the base unit 110 through the discard coupling of the base unit 110, where it may then flow to the exhaust outlet. For the container unit 120, gas may flow into the container unit 120 through the gas inlet of the container unit 120 (through the inlet coupling 121) and to the body tissue 102. Gas may then be received from the body tissue 102, where it may flow through the gas exhaust outlet of the container unit 120 (through the discard coupling).

The filters of the system 100 may be arranged to filter gas, or any other substances, which could pass through into the container unit 120 (e.g. to come into contact with the body tissue 102 being stored). The inlet filter 127 is located upstream of the body tissue 102 for the gas flow path for persufflation gas. For example, the inlet filter 127 may be provided in the region of the inlet gas coupling 121 of the container unit 120 (e.g. for filtering upstream gas about to be provided to the body tissue 102). The outlet filter 128 is located downstream of the body tissue 102 for the gas flow path for persufflation gas. For example, the outlet filter 128 may be provided in the region of the exhaust gas coupling 122 of the container unit 120 (e.g. for filtering gas about to be exhausted from the body tissue 102, and/or for filtering any substances which may be passing towards the body tissue 102 through the exhaust coupling 122). Each filter may comprise a 0.22 micron filter. The system 100 includes at least one sensor for sensing gas downstream of the body tissue 102. In other words, at least one sensor is provided somewhere along the gas flow path downstream of the body tissue 102 in the container unit 120 (e.g. somewhere between the body tissue 102 and the base unit exhaust outlet 116). A number of different example sensor locations are shown in FIG. 1. The sensor may be provided as part of the container unit 120 and/or part of the base unit 110.

Two example locations are shown for sensors in the container unit 120. The first example sensor location is the exhaust channel sensor 131, which is arranged in an exhaust channel 124 of the container unit 120. The exhaust channel sensor 131 is arranged to sense one or more properties of persufflation gas which has just passed through the body tissue 102 (and been received in the exhaust channel 124). The second example sensor location is the container unit exhaust outlet sensor 132, which is arranged at an exhaust outlet from the container unit 120 (e.g. where the exhaust coupling 122 of the container unit 120 couples to the discard coupling of the base unit 110). The exhaust outlet sensor is arranged to sense one or more properties of persufflation gas which has passed through the body and which is passing from the container unit 120 into the base unit 110 (through the exhaust outlet of the container unit 120—from the exhaust coupling 122 of the container unit 120 to the discard coupling of the base unit 110).

Two example locations are shown for sensors in the base unit 110. The third example sensor location is the base unit sensor 133, which is in the base unit 110. In particular, the base unit sensor 133 is provided in the exhausting channel (between the container unit and the base unit exhaust outlet 116). The base unit sensor 133 may be provided at some point between the discard coupling of the base unit 110 and the base unit exhaust outlet 116. The base unit sensor 133 is arranged to sense one or more properties of exhausted gas which has been received from the container unit 120 after having passed through the body tissue 102. The fourth example sensor location is the base unit exhaust outlet sensor 134. The base unit exhaust outlet sensor 134 is located at, or proximal to, the base unit exhaust outlet 116. The base unit exhaust outlet sensor 134 is arranged to sense one or more properties of persufflation gas which is about to be exhausted from the base unit 110 (e.g. gas which has passed through the body tissue 102, from the container unit 120 into the base unit 110 and then to go out through the base unit exhaust outlet 116).

Each sensor may be arranged in the gas flow path for downstream persufflation gas (which has passed through the body tissue 102). Each sensor may be arranged so that it may obtain sensor data for gas passing that sensor. For example, each sensor may be arranged so that it is in contact with the gas passing it (e.g. so that the gas will touch the sensor during use).

The system 100 may optionally include one or more sensors arranged upstream of the body tissue 102 (in the container unit 120 and/or base unit 110). The delivery channel sensor 135 is shown in FIG. 1 to illustrate this. This sensor could be provided at any location in the gas flow path upstream of the body tissue 102 (e.g. between the gas store 114 and delivery channels 123). FIG. 1 shows this sensor at, or proximal to, the gas delivery channel 123 of the container unit 120. The upstream sensor (e.g. the delivery channel sensor 135) is arranged to sense one or more properties of gas upstream of the body tissue 102. That is, the upstream sensor is arranged to sense one or more properties of persufflation gas which is to be delivered to the body tissue 102. Alternative locations for this sensor could be in the gas store 114, somewhere between the gas store 114 and the container unit 120 in the base unit 110, and/or at or around the delivery/inlet coupling 121.

The base unit 110 is arranged to house the container unit 120 and to connect the container unit 120 to a supply of persufflation gas (e.g. to the gas store 114 of the base unit 110). The container unit 120 is arranged to receive body tissue 102 to be stored and preserved. The container unit 120 may removably insertable into the housing (into the container unit receiving portion 112 of the base unit 110). The container unit lid 126 and/or the base unit lid 118 may be arranged to seal the internal volume therewithin (e.g. to seal the body tissue 102 in the container unit 120, and/or to seal the container unit 120 in the base unit 110).

The system 100 is arranged to deliver persufflation gas to the body tissue 102. The system 100 is arranged to provide a flow of persufflation gas through the body tissue 102. The base unit 110 is arranged to couple to the container unit 120 so that gas may flow into the container unit 120 from the base unit 110. The delivery channels 123 of the container unit 120 are arranged to deliver the persufflation gas into the body tissue 102. The exhaust channels 124 of the container unit 120 are arranged to receive the persufflation gas which has passed through the body tissue 102. The container unit 120 and base unit 110 are arranged to exhaust gas which has passed through the body tissue 102. For this, the system 100 is arranged to deliver persufflation gas in the container unit 120 to the base unit 110 and out through the base unit exhaust outlet 116. In other words, the system 100 is arranged to define a gas flow path for persufflation gas from a persufflation gas store 114 upstream, through the body tissue 102 in the container unit 120, and away downstream of the body tissue 102 for exhausting of said persufflation gas.

The system 100 is a persufflation system. A persufflation system is a system arranged to provide gaseous oxygen perfusion of the body tissue 102 being stored and preserved. For this, the persufflation gas may be an oxygen enriched gas (such as at 40% oxygen concentration). The persufflation system is arranged to deliver the persufflation gas to the native vasculature of the body tissue 102 being stored and preserved. The persufflation system is arranged to try to maintain the bio-energetic status of the body tissue 102. The persufflation system may be arranged to provide anterograde or retrograde persufflation. For anterograde persufflation (A-PSF), the system is arranged to provide persufflation gas which enters the body tissue 102 through one or more arteries and which drains through one or more veins. For retrograde persufflation (R-PSF), the system is arranged to provide persufflation gas which enters the body tissue 102 through one or more veins and exits through holes pricked into the surface of the organ or tissue with a needle.

The gas store 114 is a gas storage unit, such as a compressed gas tank. The gas is delivered through the body tissue 102, and ultimately vented to the atmosphere (e.g. through the base unit exhaust outlet 116). The couplings between the base unit 110 and the container unit 120 are arranged to provide a hermetic seal (e.g. so that all of the gas transfers between the container unit 120 and the base unit 110).

As described above, the system 100 includes at least one sensor arranged to sense one or more properties of downstream persufflation gas. That is, the sensor is arranged to sense one or more properties of the gas which remains in the system 100 (e.g. in the container unit 120 and/or in the base unit 110) and which has passed through the body tissue 102 being stored and preserved in the body tissue 102 receiving portion of the container unit 120. The sensor may be arranged for sensing the flow of persufflation gas as it passes the sensor (e.g. at least some of the gas may contact the sensor, from which sensor measurements for the gas may be obtained). In other examples, the sensor may be arranged to monitor a property of the gas without needing to be in contact with the gas.

Although not shown in FIG. 1, the system 100 may include a controller which is configured to receive sensor data from the one or more sensors. The controller may be provided as part of the base unit 110 and/or as part of the container unit 120. Alternatively, the system 100 may include a data communications module for transmitting the sensor data to the controller which is located externally to the system 100. The controller is configured to determine an indication of a status of the body tissue 102 based on signals received from the one or more sensors. That is, the controller is configured to determine an indication of the status of the body tissue 102 based on data indicative of one or more properties of the downstream gas which has passed through the body tissue 102.

Determining an indication of the status of the body tissue 102 may comprise predicting a ‘health’ of the body tissue 102. For example, body tissue 102, such as an organ, may be stored and preserved extracorporeally for an extended period of time, and it may be determined whether that body tissue 102 is suitable for inserting into another patient. In other words, the controller may be configured to determine whether or not a health of the body tissue 102 is greater than a threshold value (e.g. so that it may be suitable for implant into another patient). During transit, the body tissue 102 may be subject to a number of external stress factors, such as acceleration forces due to movement of a person or vehicle carrying the system 100. Over time, the status of the body tissue 102 may deteriorate while not connected to a living body. The system 100 is arranged to store and preserve the body tissue 102 to inhibit such deterioration. At the same time, the controller may be configured to monitor one or more properties of the downstream gas for determining how much the body tissue 102 is deteriorating/has deteriorated.

The controller is configured to receive sensor data indicative of one or more properties of the downstream gas from the sensor. The controller may be configured to compare this downstream sensor data with an indication of data for upstream persufflation gas. The controller may also have data (e.g. stored in a data store coupled to the controller, and/or received from an upstream sensor of the system 100, such as the delivery channel sensor 135) indicative of one or more properties of the upstream persufflation gas which has not yet been delivered to the body tissue 102. For one or more properties of the gas, the controller may be configured to determine a difference between that property of the upstream gas, and that corresponding property of the downstream gas. In other words, the controller may be configured to determine a change in one or more properties of the gas as a result of that gas passing through the body tissue 102 in the container unit 120.

The controller may be configured to determine the indication of the status of the body tissue 102 based on the determined difference in gas properties between upstream and downstream persufflation gas. The controller may be configured to determine an uptake metric for the body tissue 102 based on the determined difference. In other words, the controller may be configured to attribute the difference in upstream and downstream gas properties to an operational characteristic of the body tissue 102 being stored. The controller may associate a change in the gas property brought about by passing that gas through the body tissue 102 with a corresponding status of the body tissue 102.

The controller may monitor the difference between the upstream and downstream gas properties, and may determine the status of the body tissue 102 based on at least one of: (i) a magnitude of the difference between properties of the upstream and downstream gas, (ii) any changes in the difference between properties of the upstream and downstream gas, and (iii) a rate of change of the difference between the properties of the upstream and downstream gas. The controller may determine the status of the body tissue 102 by attributing the difference, or any changes to this difference, to the status of the body tissue 102 in the container unit 120. For example, the controller may determine that the body tissue 102 is in a ‘healthy’ state in the event that the determined difference remains in a selected range, and/or the change of difference/rate of change of difference remains in a selected range. Conversely, the controller may determine that the body tissue 102 is in an ‘unhealthy’ state in the event that the determined difference lies outside a selected range, or the change of difference/rate of change of difference exceeds lies outside a selected range.

The controller may be configured to determine the status of the body tissue 102 based on cumulative determined difference data. For example, the controller may be configured to determine the status based on a combination of many different readings from the sensor over time. This may be in the form of a weighted sum associated with a combination of the difference value and the amount of time spent with that difference value.

The controller may be configured to monitor such difference data during the time that the system 100 stores the body tissue 102. The controller may be configured to determine the status of the body tissue 102 to provide an instantaneous status metric (e.g. a determined status for the body tissue 102 based on current sensor data) and/or a cumulative status metric (e.g. a determined status for the body tissue 102 based on previous sensor data for the body tissue 102 while it has been stored in the container unit 120). The controller may be configured to apply a windowing approach in which status is determined based on a selected window of data, such as a selected subset of the sensor data for the body tissue 102 while it has been stored in the container unit 120. The selected window may comprise only the portions of sensor data where the difference or change/rate of change of difference lies outside the selected range. The selected window may comprise a window in time for a selected amount of time for previous sensor data.

The controller may be configured to apply a data filter to initial sensor data associated with the start of storage and preservation of body tissue 102 in the system 100. Applying the data filter may comprise disregarding initial sensor data associated with an initial time period of operation for the system 100, and/or it may comprise applying a weighting to that initial sensor data (e.g. so that it contributes less to the determination of the status of the body tissue 102). As will be appreciated in the context of the present disclosure, storage and preservation of the body tissue 102 may commence with an initial period when the persufflation gas is first applied to the body tissue 102, and then a subsequent steady state period may occur once the persufflation gas flow has reached an equilibrium state. During the initial period, there may be some substances in the body tissue 102 from prior to the storage and preservation in the system 100 occurring. These substances may be flushed out with persufflation gas passing through the body tissue 102. The initial filtering of data may be controlled so that sensor data indicative of these substances previously in the body tissue 102 carries less weight/is disregarded. This initial filtering of data may continue until a steady state is reached where it is persufflation gas entering the body tissue 102 and (used) persufflation gas exiting the body tissue 102 (without substantial other substances being included). For example, the initial time period may be selected so that any ambient fluids, such as those that were previously in the body tissue 102 or components of the body tissue preservation system, will have been discarded by the system 100 (e.g. after having passed through the body tissue 102). For example, the controller may be configured to detect that downstream sensor data indicates that a steady state storage condition has been reached (e.g. that all ambient substances have been flushed from the body tissue 102), and to switch to a mode in which downstream sensor data is monitored (e.g. it is no longer discarded/data filtered).

As one example, the sensor may be arranged to sense an oxygen concentration for the persufflation gas. The upstream persufflation gas (which has not yet been delivered to the body tissue 102) may have a known, or sensed, oxygen concentration. For example, persufflation gas may be stored in the persufflation gas store 114 with a known oxygen concentration (e.g. 40% oxygen enriched persufflation gas). The sensor may be arranged to obtain an indication of oxygen concentration for the downstream persufflation gas (which has passed through the body tissue 102). The controller may be configured to compare the downstream oxygen concentration with the upstream oxygen concentration. The controller may determine a difference between the two, and to determine therefrom an indication of an amount of oxygen which has been consumed by the body tissue 102 (e.g. taken up/absorbed into the body tissue 102). The controller may determine a status of the body tissue 102 based on the determined oxygen consumption of the body tissue 102. For example, if consumption is below a threshold amount, and/or is decreasing at above a selected rate, the controller may determine that the status of the body tissue 102 is unhealthy (or becoming unhealthy). Conversely, the controller may determine that the body tissue 102 is healthy in the event that the oxygen consumption by the body tissue 102 lies in a selected range (and is not changing by more than a threshold amount/rate).

It will be appreciated in the context of the present disclosure that oxygen concentration is just one measurand, and others could be used additionally to, or instead of, oxygen concentration. For example, the system 100 may be configured to determine a status of the body tissue 102 based on a difference in persufflation gas temperature, humidity and/or pressure, and/or the presence or absence of other substances (e.g. VOCs, TVOCs etc.).

The controller may be configured to receive additional data relating to the body tissue 102 being stored and/or operation of the system 100. For example, the controller may receive other data, such as temperature, pressure and/or humidity data for the inside of the organ receiving portion of the container unit 120 (e.g. from one or more sensors positioned inside the container unit 120), movement data for the system 100 (e.g. from an accelerometer), and/or timing data associated with an amount of time for which the body tissue 102 has been stored (e.g. from a timing device of the system 100). The controller may be configured to determine a status of the body tissue 102 based on both: (i) downstream sensor data (and e.g. differences between the downstream and upstream persufflation gases), and (ii) additional data. For example, the controller may be configured to cross-correlate data from different sensors (e.g. so that fluctuations in one data stream could be attributed to causes associated with another data stream, rather than issues with the body tissue 102 itself). The controller may be configured to filter any difference data for the difference between downstream and upstream persufflation gas in the event that data from an additional sensor for the same time period as that additional data suggested a cause for any changes to the difference data during that time period. As one example, the controller may be configured to reduce the impact of (e.g. filter out/disregard) a temporary drop in determined oxygen absorption of the body tissue 102 that occurred simultaneously with a measured significant change in acceleration of the system 100.

The provision of one or more downstream sensors may advantageously provide an additional data stream for monitoring the body tissue 102 being stored. Additionally, the downstream sensors may not need to come into contact with the body tissue 102 itself, which may help to avoid damaging (or contaminating) the body tissue 102, and may reduce demands on sterilisation of the sensor devices. As a result, less expensive sensors may be needed for providing insight as to the status of the body tissue 102 being stored. The sensors may be provided in locations which are easier to access. This may allow the sensors to be easier to inspect and/or replace, as well as to simplify communication arrangements between sensor and controller (e.g. it may avoid the need for wireless communication capabilities for sensors, and/or may avoid the need for complex wiring arrangements/wires being present in the container unit 120). Where sensors are provided in the base unit 110, these may be reusable sensors. The base unit 110 may house the controller, and so connecting base unit sensors to the controller may be simplified (as compared to connecting from the container unit 120), while still enabling these sensors to obtain an indication of useful data for monitoring the status of the body tissue 102 being stored and preserved in the container unit 120.

As described above, the controller may be configured to determine a status of the body tissue 102 being stored and preserved in the container unit 120 based on obtained sensor data for one or more properties of the downstream persufflation gas. The controller may be configured to control operation of the system 100 based on its determined status for the body tissue 102. As described in more detail below, the controller may be configured to control operation in a number of different ways. One way would be to provide a dynamic feedback system 100 in which the controller may actively control operation of different components of the system 100 based on the sensed data for downstream persufflation gas. Another way would be to output one or more alerts in the event that the downstream sensor data indicated a potential issue with the tissue being stored (e.g. so that a human operator of the system 100 may take appropriate action).

The controller may be arranged to output a control signal based on downstream sensor data received from the one or more sensors. The control signal may be configured to control operation of the system 100, and/or it may comprise an alert for alerting an operator of the system 100 (and providing an option for them to input feedback). The control may be configured to output the control signal in the event that an alert condition is detected. The controller may detect that an alert condition is present based on the difference between upstream and downstream persufflation gas properties. For example, the controller may detect an alert in the event that the determined difference between the upstream persufflation gas and the downstream persufflation gas is outside a selected difference range, and/or that the difference has changed by more than a threshold amount/at greater than a threshold rate of change. In other words, the controller may be configured to determine, based on the downstream sensor data, that one or more parameters for the storage and preservation of the body tissue 102 should be adjusted.

The base unit 110 may be arranged to regulate the flow of persufflation gas to the body tissue 102 (e.g. rate of flow/flow pressure/flow temperature) and/or to control the ambient conditions in the body tissue receiving portion of the container unit 120 (e.g. temperature/pressure/humidity). The controller may be configured to adjust one or more of the parameters based on the downstream sensor data. That is, the controller may be configured to determine that the storage and preservation of the body tissue 102 is suboptimal based on the downstream sensor data, and the controller may be configured to adjust operation of the system 100 to improve the storage and preservation of the body tissue 102.

For example, in the event that the controller determines that the downstream oxygen concentration is below a threshold value (e.g. the difference between upstream and downstream is above a threshold value), the controller may determine that more oxygen is required for the body tissue 102. In such an event, the controller may control operation of the system 100 (e.g. the base unit 110) to increase an amount of oxygen provided to the body tissue 102. For example, the controller may control operation of one or more valves or pumps of the base unit 110 to increase an amount of persufflation gas provided to the body tissue 102 per unit time (e.g. to increase the rate at which persufflation gas is applied to the body tissue 102). As such, there may be more oxygen passing through the body tissue 102 per unit time, which may enable the body tissue 102 to have a greater amount of oxygen uptake. The controller may be configured to monitor the oxygen uptake for the body tissue 102 and to adjust the properties of the operation of the system 100 so that this oxygen concentration remains in a selected range. For example, the controller may decrease the gas flow rate in the event that the difference between the downstream and upstream oxygen concentrations is too low. As a result, the controller may control operation of the system 100 to inhibit too much persufflation gas/oxygen wastage by providing too much persufflation gas to the body tissue 102, and/or the controller may control operation of the system 100 to inhibit instances where there is not enough oxygen provided to the body tissue 102 being stored and preserved.

Additionally or alternatively, the controller may be configured to determine that an alert condition is present and to output an alert for an operator of the device to control operation of the system 100 based on the alert. For example, as described above, the controller may be configured to determine that one or more operational parameters of the system 100 may be leading to suboptimal conditions for the storage and preservation of body tissue 102. In the event that the controller determines that this is the case, the controller may output an alert (e.g. an audible and/or visible alert) to an operator of the system 100. The alert may comprise an indication that one or more conditions for body tissue storage and preservation are not satisfactory. For example, the alert may contain an indication of what the determined issue is, and a suggested fix for the issue. The alert may comprise an option for a suggested cause of action and the user may interact with the controller to instruct the controller to control operation of the system 100 accordingly (e.g. agree/disagree to selected action).

For example, as with the example above, the controller may determine that more or less oxygen is required for the body tissue 102. The controller may output an alert indicating this to the operator. The alert may provide a suggestion that the persufflation gas flow rate should be increased or decreased. The operator may interact with the controller to confirm or deny that the controller should adjust the flow rate, and/or to specify by how much the flow rate should be adjusted. The controller may then control operation of the system 100 accordingly.

Additionally or alternatively, the controller may be configured to store each indication of an alert condition occurring in a data store. The controller may be configured to output data for a physician to review prior to implanting the body tissue 102 into the patient. For example, shortly prior to the body tissue 102 being inserted into the patient, the physician may review the data for the storage and preservation of the body tissue 102 to determine if the body tissue 102 remains suitable for (re-)use. The controller may be configured to condense all of the sensor data to reduce the amount of data the physician needs to review. For this, the controller may be configured to output an indication of any instances during the storage and preservation when an alert condition was triggered (e.g. if oxygen consumption seemed too low for the body tissue 102). The physician may determine whether or not to implant based on this abridged version of the sensor data for the storage and preservation of the body tissue 102.

In operation, the system 100 is assembled for storage and preservation of the body tissue 102. The body tissue 102 is inserted into the container unit 120, and the delivery and exhaust channels 124 are coupled to the body tissue 102. The container unit lid 126 may then be closed to seal the body tissue 102 within the container unit 120. The container unit 120 is connected to the base unit 110 by inserting the container unit 120 into the container unit receiving portion 112 of the base unit 110. The two couplings of the container unit 120 (inlet coupling 121 and exhaust coupling 122) are coupled to their associated couplings of the base unit 110 (delivery coupling and discard coupling). As such, a gas flow path may be provided for delivering persufflation gas from the persufflation gas store 114 in the base unit 110 through into the container unit 120, through the body tissue 102, back from the container unit 120 into the base unit 110 and for exhausting from the base unit 110. The lid 118 of the base unit 110 may be closed to seal the container unit 120 within the base unit 110.

For storage and preservation, the persufflation gas is delivered to the body tissue 102. Persufflation gas will flow from upstream to downstream through the body tissue 102. Sensor data is obtained for gas downstream of the body tissue 102. The controller uses this downstream sensor data to determine a status of the body. Typically, this includes comparing the downstream data to the upstream data to identify differences therebetween. Any such differences may be attributed to the condition of the body tissue 102, and so they may be used for determining the status of the body tissue 102.

Examples described above relate to body tissue preservation systems and methods for storage and preservation of body tissue 102. However, it will be appreciated in the context of the present disclosure that the features described in these examples are not intended to be considered limiting. In particular, a number of features have been described to illustrate examples of how these features may be provided and/or what functionality they may provide. This description is just to illustrate possible options. Some of these features may be provided in an alternative manner, or they may not be provided at all.

For example, in the examples described above, a gas flow path is defined which extends from the gas store 114, through the body tissue 102 in the container unit 120 and back into the base unit 110 for discarding therefrom. However, this is just one example of a gas flow path that could be used. It will be appreciated that the present disclosure relates to the use of downstream sensors. As such, any suitable flow path may be defined which has one or more downstream sections for exhausting the gas which has passed through the body tissue 102. The sensors of the present disclosure may be provided in such a downstream location.

For example, the delivery and/or exhaust channels 124 of the container unit 120 may not be used. In particular, as described above for examples where the system 100 provides retrograde persufflation, the system 100 may provide persufflation gas which enters the body tissue 102 through one or more veins and exits through holes pricked into the surface of the organ or tissue with a needle. As such, no exhaust channels 124 will be provided. In which case, the exhaust outlet of the container unit 120 may comprise a vent for exhausting persufflation gas. The sensors may be provided in the container unit 120 (to measure properties of the gas which has passed through the body tissue 102), at the exhaust outlet (where the gas is being vented), or further downstream in the base unit 110 (where the exhausted gas is received from the container unit 120 and/or subsequently vented from the base unit 110).

As another example, the base unit 110 need not include a base unit exhaust outlet 116 as described above. Instead, the base unit may contain a storage region, such as a gas tank, for used persufflation gas (e.g. for persufflation gas which has passed through the body tissue 102 being stored and back into the base unit for storage and subsequent removal). In which case, a sensor may be provided for gas entering into that storage region.

In the examples described above, the container unit 120 includes one or more filters. However, these need not be provided. Instead, the container unit 120 could have no filters, or filters may be provided as part of the base unit instead. Additionally, the base unit has been described as having a gas store 114 for storing persufflation gas to be provided to the body tissue 102 (and optionally for used persufflation gas). However, these features could instead be provided by external components (e.g. at locations external to the base unit). It will also be appreciated in the context of the present disclosure that the steps of methods described herein could be performed in different orders to that described. For example, the body tissue 102 could be placed into the container unit 120, and the container unit 120 subsequently placed into the base unit, or, alternatively, the container unit 120 could be placed into the base unit with the body tissue 102 then placed into the container unit 120.

It will be appreciated from the discussion above that the example shown in the figure is merely exemplary, and includes features which may be generalised, removed or replaced as described herein and as set out in the claims. With reference to the drawings in general, it will be appreciated that schematic functional block diagrams are used to indicate functionality of systems and apparatus described herein. In addition the processing functionality may also be provided by devices which are supported by an electronic device. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some examples the function of one or more elements shown in the drawings may be integrated into a single functional unit.

As will be appreciated by the skilled reader in the context of the present disclosure, each of the examples described herein may be implemented in a variety of different ways. Any feature of any aspects of the disclosure may be combined with any of the other aspects of the disclosure. For example method aspects may be combined with apparatus aspects, and features described with reference to the operation of particular elements of apparatus may be provided in methods which do not use those particular types of apparatus. In addition, each of the features of each of the examples is intended to be separable from the features which it is described in combination with, unless it is expressly stated that some other feature is essential to its operation. Each of these separable features may of course be combined with any of the other features of the examples in which it is described, or with any of the other features or combination of features of any of the other examples described herein. Furthermore, equivalents and modifications not described above may also be employed without departing from the invention.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates.

Any controller described herein may be provided by any control apparatus such as a general purpose processor configured with a computer program product configured to program the processor to operate according to any one of the methods described herein. In addition, the functionality of the controller may be provided by an application specific integrated circuit, ASIC, or by a field programmable gate array, FPGA, or by a configuration of logic gates, or by any other control apparatus.

Other examples and variations of the disclosure will be apparent to the skilled addressee in the context of the present disclosure.

1. A body tissue preservation system for storage and preservation of body tissue, the system comprising a base unit, a container unit, a sensor and a controller, wherein:
the base unit is arranged to house the container unit and to connect the container unit to a supply of persufflation gas;
the container unit is arranged to receive body tissue to be stored and preserved, and comprises one or more delivery channels arranged to receive persufflation gas from the base unit and to deliver said persufflation gas to the body tissue;
the sensor is arranged to sense one or more properties of downstream persufflation gas which has passed through the body tissue; and
the controller is configured to determine an indication of a status of the body tissue based on the one or more sensed properties of the downstream persufflation gas.

2. The body tissue preservation system of claim 1, wherein determining an indication of a status of the body tissue comprises determining a difference between: (i) a sensed property of the downstream persufflation gas, and (ii) a corresponding property of upstream persufflation gas to be provided to the body tissue.

3. The body tissue preservation system of claim 2, wherein determining an indication of the status of the body tissue comprises determining an uptake metric for the body tissue based on the determined difference between downstream and upstream persufflation gas.

4. The body tissue preservation system of claim 1, wherein the sensor comprises an oxygen sensor.

5. The body tissue preservation system of claim 4, wherein determining an indication of a status of the body tissue comprises determining a difference between: (i) a sensed property of the downstream persufflation gas, and (ii) a corresponding property of upstream persufflation gas to be provided to the body tissue, and wherein determining the status of the body tissue comprises determining an amount of oxygen uptake into the body tissue.

6. The body tissue preservation system of claim 5, wherein the determined amount of oxygen uptake into the body tissue is based on a difference in oxygen concentration for upstream persufflation gas to be provided to the body tissue and downstream persufflation gas which has passed through the body tissue.

7. The body tissue preservation system of claim 2, wherein the controller is arranged to output a control signal in the event that at least one of: (i) the determined difference between the upstream persufflation gas and the downstream persufflation gas is outside a selected difference range, (ii) the determined difference has changed by more than a threshold amount, and/or (iii) the determined difference has changed at more than a threshold rate of change.

8. The body tissue preservation system of claim 7, wherein outputting a command signal comprises at least one of: (i) controlling operation of the body tissue preservation system based on the determined difference, and (ii) outputting a signal indicating that the determined difference is outside the selected difference range.

9. The body tissue preservation system of claim 1, wherein the controller is configured to disregard initial sensor data for the downstream persufflation gas for an initial time period after the persufflation gas is first delivered to the body tissue.

10. The body tissue preservation system of claim 9, wherein the initial time period is selected to enable ambient fluid to pass through the body tissue and be discarded.

11. The body tissue preservation system of claim 1, wherein the sensor is configured to sense one or more biological properties in the downstream persufflation gas.

12. The body tissue preservation system of claim 1, wherein the container unit comprises a container unit exhaust outlet for discarding gas which has passed through the body tissue from the container unit.

13. The body tissue preservation system of claim 12, further comprising a filter at the container unit exhaust outlet.

14. The body tissue preservation system of claim 12, wherein the sensor is arranged to sense one or more properties of the downstream gas passing through the container unit exhaust outlet.

15. The body tissue preservation system of claim 12, wherein the base unit is coupled to the container unit exhaust outlet to receive the gas being discarded from the container unit.

16. The body tissue preservation system of claim 15, wherein the sensor is arranged to sense one or more properties of the gas in the base unit which has been received from the container unit exhaust outlet.

17. The body tissue preservation system of claim 15, wherein the base unit comprises a base unit exhaust outlet for discarding the gas received from the container unit exhaust outlet.

18. (canceled)

19. The body tissue preservation system of claim 1, wherein the container unit comprises one or more exhaust channels arranged to receive persufflation gas which has passed through the body tissue from the delivery channels.

20. (canceled)

21. (canceled)

22. A container unit for a body tissue preservation system for storage and preservation of body tissue, wherein:
the container unit is arranged to receive body tissue to be stored and preserved;
the container unit is arranged to be coupled to a base unit to be connected to a supply of persufflation gas;
the container unit comprises one or more delivery channels arranged to receive persufflation gas from said base unit and to deliver the persufflation gas to the body tissue; and
the container unit comprises a sensor arranged to sense one or more properties of downstream persufflation gas which has passed through the body tissue and to output one or more signals indicative of said sensed one or more properties of the downstream persufflation gas to enable a controller to determine an indication of a status of the body tissue based on the one or more sensed properties of the downstream persufflation gas.

23. A base unit for a body tissue preservation system for storage and preservation of body tissue, wherein:
the base unit is arranged to receive a container unit arranged to receive body tissue to be stored and preserved;
the base unit is arranged to be coupled to said container unit to connect said container unit to a supply of persufflation gas for delivering the persufflation gas to the body tissue via one or more delivery channels of the container unit;
the base unit is arranged to be coupled to said container unit to receive, from the container unit, downstream persufflation gas which has passed through the body tissue; and
the base unit comprises a sensor arranged to sense one or more properties of the downstream persufflation gas which has passed through the body tissue and to output one or more signals indicative of said sensed one or more properties of the downstream persufflation gas to enable a controller to determine an indication of a status of the body tissue based on the one or more sensed properties of the downstream persufflation gas.

24. (canceled)

25. (canceled)
